(19) United States
(12) Patent Application Publication
(10) Pub. No.: US 2025/0364906 A1
(43) Pub. Date: Nov. 27, 2025

(54) Power Factor Correction with Power Balancing Control for Three-Phase Single-Stage AC-DC Converters

(71) Applicant: Queen's University at Kingston, Kingston (CA)

(72) Inventors: Mojtaba Forouzesh, Kingston (CA); Yan-Fei Liu, Kingston (CA)

(21) Appl. No.: 18/874,794

(22) PCT Filed: Jun. 21, 2023
(86) PCT No.: PCT/CA2023/050867

§ 371 Date: Dec. 13, 2024

Related U.S. Application Data
(60) Provisional application No. 63/354,529, filed on Jun. 22, 2022.

(51) Int. Cl. H02M 1/42; H02M 1/00; H02M 3/00; H02M 3/335; H02M 7/217

(52) U.S. Cl. CPC H02M 1/4216; H02M 1/0003; H02M 1/4241; H02M 3/01; H02M 3/33573; H02M 7/217

(57) ABSTRACT

Control strategies for phase-modular three-phase single-stage AC-DC converters with simultaneous power factor correction and power balancing features substantially cancel double line frequency ripple in the converter output voltage that is caused by an imbalance in the three-phase input voltages. The output capacitance of three-phase converters may be small even in the presence of unbalanced input voltages and power losses. A high-power factor (i.e., >0.99) may be achieved in both balanced and unbalanced input phase voltage conditions with and without input voltage harmonics.

### RELATED APPLICATION

This application claims the benefit of the filing date of Application No. 63/354,529, filed Jun. 22, 2022, the contents of which are incorporated herein by reference in their entirety.

### FIELD

This invention relates generally to controllers and control methods for three-phase AC-DC converters. In particular, the invention relates to controllers and methods that employ a feedback loop for power balancing for phase-modular three-phase AC-DC converters that substantially eliminates double line frequency ripple in the converter output voltage caused by an imbalance in the converter input power.

### BACKGROUND

Three-phase AC-DC converters play an essential role in high power systems that are directly connected to the utility grid. Power Factor Correction (PFC) rectifiers provide sinusoidal currents with near-unity power factor and a stable bus voltage. Conventionally, three-phase rectifiers consist of two separate cascaded connected converters, the first stage is usually a three-phase AC-DC converter for PFC and the second stage is a DC-DC converter that provides voltage isolation and regulation, and many three-phase two-stage AC-DC converters with different topologies have been proposed. A general structure of two-stage three-phase AC-DC converters with PFC is shown in FIG. 1. The first part is usually a non-isolated three-phase boost converter that performs PFC, and the second stage is an isolated DC-DC converter that performs voltage regulation. Unbalanced three-phase input voltages do not harm the output voltage of a two-stage AC-DC converter as the second-stage DC-DC converter can regulate the output voltage to a pure DC level. However, the two-stage approach has drawbacks such as low conversion efficiency due to multiple power processing stages and low power density due to large passive components such as boost inductors, DC-link electrolytic capacitors, and a high number of components. Since DC-link electrolytic capacitors have a short life span, usually less than 5,000 hours, reliability of converters based on the two-stage approach is reduced.

Using three separate AC-DC converter modules in three-phase systems, referred to as phase-modular three-phase power conversion, is an interesting approach for three-phase AC-DC conversion as all the knowledge of single-phase PFC converters can be used for the three-phase system. Moreover, the reactive power in three-phase systems with 120-degree phase shift cancels out and there is no need for large output capacitance. The phase-modular structure can be implemented with two stages, which usually demands relatively large DC-link capacitors on each phase and the power conversion efficiency is low compared to single-stage approaches. Different single-stage topologies have been investigated in phase-modular three-phase AC-DC converter structure, including active clamp boost converter [1], flyback converter [2], SEPIC converter [3], Zeta converter [4], Cuk converter [5], full-bridge converter [6], push-pull converter [7], Dual Active Bridge (DAB) converter [8], and LLC resonant converter [9]. Most of this literature only discusses the implementation and power circuit performance in either four-wire or three-wire three-phase systems using conventional current control methods.

One main challenge for three-phase AC-DC converters is the presence of double line frequency output ripple in case of any imbalance in the three-phase input voltages. This problem comes from unbalanced power-sharing between the three phases due to unbalanced input voltages and fixed current references for the phases. This issue becomes critical in single-stage AC-DC converters as there is no post-regulation DC-DC stage to remove the low-frequency voltage ripple caused by unbalanced input voltages. Double line frequency voltage ripple at the output can generate current ripple, which can reduce the efficiency and lifetime of the DC load. For example, in battery charging systems it can lead to overheating and reduced lifetime of the battery pack which is an expensive part of any system [10]. Therefore, a power balancing circuit is needed for single-stage three-phase AC-DC converters to fully benefit from the small output capacitance feature.

Little research can be found concerning the impact of unbalances on phase-modular three-phase AC-DC converters. In [11] and [12] power balancing control is done based on inductor current calculation for each phase using input voltage, output voltage, and output current. The calculation of the inductor current resulted in the output voltage of the converter becoming independent of the variation in input voltage and DC load current. In [8], simple power control balancing was implemented in a phase-modular three-phase DAB AC-DC converter. This method reads the output current through a low pass filter on each phase and then creates a reference current based on the input voltage to do the power balancing, hence this method has slow dynamics and requires additional sensing circuits.

In some approaches, the input admittance balancing technique is used with unbalanced input voltages to achieve different goals. In [13] and [14], input admittance balancing is used in two-stage three-phase AC-DC converters with wye-connected input rectifiers. The input admittance is balanced in these topologies to make the virtual neutral point voltage steady even with unbalanced grid voltages. In [15], input admittance balancing is used in a three-phase single-stage AC-DC converter to limit the excessive current through each module in case of unbalanced input voltages. In all these cases, the power distribution between modules should be unbalanced to achieve the required goals and the systems suffer from slow dynamics as there are multiple loops with respective filters in the control system.

### SUMMARY

According to one aspect of the invention there is provided a controller for a three phase power converter, comprising: a first circuit that determines an instantaneous input power of each phase; a feedback circuit that determines at least one power control signal based on an output of the three phase power converter; a second circuit that uses the power control signal to adjust the instantaneous input power of each phase to achieve power balancing of the three phases; wherein a double line frequency ripple in an output power of the three phase converter is substantially eliminated.

In one embodiment the first circuit senses an input current and an input voltage for each phase, and determines the instantaneous input power for each phase; the feedback circuit senses an output voltage of the three phase converter and determines the power control signal for each phase; the second circuit uses the power control signal for each phase together with a feature of the input voltage for each phase to determine a reference power signal for each phase, and compares the reference power signal for each phase to the instantaneous input power for each phase to generate a control signal for each phase; an output circuit uses the control signal for each phase to generate drive signals for switching devices of power circuits of each phase of the three phase power converter to achieve the power balancing of the three phases.

In one embodiment the feature of the input voltage for each phase is determined according to 1-cos(2ωt).

In one embodiment the feedback circuit senses an output voltage and an output current of the three-phase converter; wherein the controller uses the sensed output voltage to determine the power control signal for each phase, and uses the power control signal for each phase together with the feature of the input voltage for each phase to determine a reference current signal for each phase; wherein the controller uses the sensed output current and voltage to determine an output power of the three-phase converter; wherein the output power is used to determine an instantaneous input current of each phase that is used with the reference current signal for each phase to generate the control signal for each phase.

In one embodiment the feature of the input voltage for each phase is determined according to sin(ωt).

In one embodiment the feedback circuit senses the output voltage of the three phase converter and an output current of each phase to determine the power control signal for each phase, and uses the power control signal for each phase together with a feature of the input voltage for each phase to determine the reference power signal for each phase.

In one embodiment the feature of the input voltage for each phase is determined according to 1-cos(2ωt).

In one embodiment the first circuit comprises an average input current calculator that calculates an average input current for each phase in each switching cycle.

In one embodiment the feedback circuit determines an average value of the sensed output currents of the three phases over a half-line cycle, compares the output current of each phase to the average value of the three phase currents, and subjects the output of the comparison for each phase to a compensator to obtain an adjusting power signal for each phase.

In one embodiment the feature of the input voltage is determined at a zero-crossing point of the input voltage of each phase.

In one embodiment the feedback circuit compares a sensed output voltage of the three phase converter to a reference voltage, and uses the output of the comparison to obtain a proper amplitude of the at least one power control signal.

Embodiments may comprise an output circuit including pulse width modulation (PWM) modules that generate switching signals for switching devices of power converter modules of the three phase power converter.

Embodiments may comprise an output circuit including pulse frequency modulation (PFM) modules that generate switching signals for switching devices of power converter modules of the three phase power converter.

Embodiments may be implemented for a three-phase power converter configured for a phase voltage connected three-phase power source.

Embodiments may be implemented for a three-phase power converter configured for a line voltage connected three-phase power source.

According to another aspect of the invention there is provided a three phase power converter comprising a controller as described herein.

According to another aspect of the invention there is provided a method for controlling a three phase power converter, comprising: determining an instantaneous input power of each phase; determining a power control signal for each phase based on an output power of the three phase power converter; using the power control signal to determine a reference signal for each phase; using the reference signal for each phase to adjust the instantaneous input power of each phase to achieve power balancing of the three phases; wherein a double line frequency ripple in the ouput power of the three phase converter is substantially eliminated.

One embodiment comprises sensing an input current and an input voltage for each phase of the three-phase converter, and determining the instantaneous input power for each phase; using a feedback circuit that senses an output voltage of the three phase converter to determine the power control signal for each phase; using the power control signal for each phase together with a feature of the input voltage for each phase to determine a reference power signal for each phase; comparing the reference power signal for each phase to the instantaneous input power for each phase to generate a control signal for each phase; using the control signal for each phase to generate drive signals for switching devices of power circuits of each phase of the three phase power converter.

In one embodiment the feature of the input voltage for each phase is determined according to 1-cos(2ωt).

In one embodiment the feedback circuit senses the output voltage and an output current of the three-phase converter; the method comprising using the sensed output voltage to determine the power control signal for each phase, and using the power control signal for each phase together with a feature of the input voltage for each phase to determine a reference current signal for each phase; using the sensed output current and voltage to determine an output power of the three-phase converter; using the output power to determine an instantaneous input current of each phase that is used with the reference current signal for each phase to generate the control signal for each phase.

In one embodiment the feature of the input voltage for each phase is determined according to sin(ωt).

In one embodiment the feedback circuit senses the output voltage of the three phase converter and an output current of each phase to determine the power control signal for each phase; the method comprising using the power control signal for each phase together with a feature of the input voltage for each phase to determine the reference power signal for each phase.

In one embodiment the feature of the input voltage for each phase is determined according to 1-cos(2ωt).

One embodiment comprises using pulse width modulation (PWM) to generate switching signals for switching devices of power converter modules of the three phase power converter to achieve power balancing of the three phases.

One embodiment comprises using pulse frequency modulation (PFM) to generate switching signals for switching devices of power converter modules of the three phase power converter to achieve power balancing of the three phases.

According to embodiments, double line frequency ripple in the output power of the three-phase converter is substantially eliminated with balanced input voltage and with unbalanced input voltage, and when input voltage harmonics are present.

### BRIEF DESCRIPTION OF THE DRAWINGS

For a greater understanding of the invention, and to show more clearly how it may be carried into effect, embodiments will be described, by way of example, with reference to the accompanying drawings, wherein:

FIG. 1 is a block diagram of a generalized structure of a three-phase two-stage AC-DC converter, according to the prior art.

FIG. 2A is a block diagram of a generalized structure of a phase-modular three-phase single-stage AC-DC converter, according to the prior art.

FIG. 2B is a block diagram of a phase-modular four-wire three-phase (wye configuration) AC-DC converter, according to the prior art.

FIG. 2C is a block diagram of a phase-modular three-wire three-phase system (delta configuration) AC-DC converter, according to the prior art.

FIGS. 3A and 3B are schematic diagrams of single-stage PFC converter modules, including a duty cycle controlled PWM isolated Boost converter and a frequency controlled PFM LLC resonant converter, respectively, according to the prior art.

FIG. 4 shows graphs representing AC input voltages, currents, and instantaneous power of each module (a, b, c) and the total power of a three-phase converter.

FIG. 5 shows graphs representing three-phase input voltages, currents, and powers considering some harmonics in the grid voltages using a power control method according to an embodiment described herein.

FIGS. 6A-6C are control block diagrams of PFC and power balancing strategies for phase-modular three-phase single-stage AC-DC converters according to embodiments described herein.

FIG. 6D is a shematic diagram of a digital implementation of a PFC and power balancing control method for a phase-modular three-phase single-stage LLC AC-DC converter, according to one embodiment.

FIG. 7 are plots of simulation results for a phase-modular three-phase single-stage LLC AC-DC converter with power balancing control strategy, with and without input voltage harmonics, according to one embodiment.

FIG. 8 are plots of simulation results for a phase-modular three-phase LLC AC-DC converter with conventional constant current control under a 15% step decrease in input voltage V_a occurring at 80 ms.

FIG. 9 are plots of simulation results for a phase-modular three-phase LLC AC-DC converter with power balancing control strategy according to one embodiment, under 15% step decrease in input voltage V_a occurring at 80 ms.

FIGS. 10A and 10B are plots of simulation results for a phase-modular three-phase LLC AC-DC converter with power balancing control strategy according to one embodiment, with 5% efficiency reduction on phase C, (A) with only feedforward power balancing loop, and (B) with both feedforward and feedback power balancing loops.

FIG. 10C are plots of simulation results for a phase-modular three-phase LLC AC-DC converter with power balancing control strategy according to one embodiment, when input AC voltages are unbalanced and contain different harmonics.

FIGS. 11A-11D are oscilloscope screen shots showing results for an experimental prototype operating at Pₒ=1.5 kW and Vₒ=380 V, wherein FIGS. 11A and 11B were obtained using conventional constant current control with balanced input voltages and unbalanced input voltages, respectively, and FIGS. 11C and 11D were obtained using power balancing control according to an embodiment described herein with balanced input voltages and unbalanced input voltages, respectively.

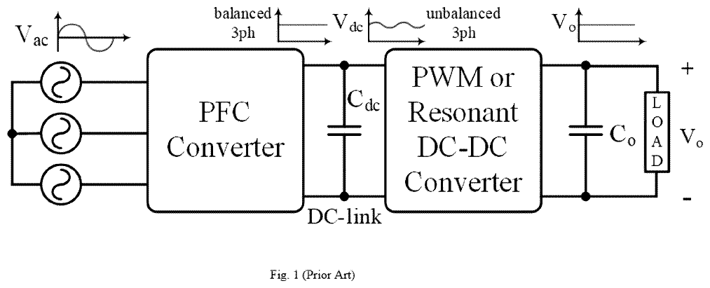

### DETAILED DESCRIPTION OF EMBODIMENTS

The output voltage of phase-modular three-phase single-stage AC-DC converters includes a double line frequency ripple when there is a slight voltage imbalance in the input source, which is inevitable in three-phase systems. One of the main advantages of phase-modular three-phase single-stage AC-DC converters is the small output capacitance requirement, which is due to the double line frequency current cancellation of the three-phase system in the output of the converter. However, this can be impaired by any voltage imbalance between the phases of the grid voltage.

Power control methods and controllers are provided herein for three-phase single-stage AC-DC converters to achieve both power factor correction (PFC) and power balancing at the same time. According to embodiments, an instantaneous input power calculation is implemented to create a fast feedforward loop for power balancing. Moreover, as the output power may not have the same correlation of the input power, the average output current of each phase may also be sensed to be used in a feedback loop to fine-tune the output power balancing. According to embodiments only small output capacitors are required, removing the need for electrolytic capacitors (E-Cap) for phase-modular three-phase single-stage PFC AC-DC converters even with unbalanced three phases. These features improve power density and reliability of phase-modular three-phase single-stage rectifiers. Embodiments are described herein, and an embodiment comprising a three-phase single-stage LLC-based AC-DC converter is described as an example and used to validate the performance of the power balancing control method.

Accordingly, described herein are PFC control methods and controllers with fast power balancing for phase-modular three-phase AC-DC structures. In some embodiments, the double line frequency ripple of the output current is completely or substantially removed by performing power balancing between the phases. Moreover, the effect of unbalanced power due to an imbalance in the magnitude of input voltages on each phase is solved while achieving PFC, so the dynamic of the system is fast. Furthermore, a feedback loop may also be implemented by sensing the output current of each phase for accurate control of the output power balancing. As described herein, different voltage imbalance conditions are simulated and compared with the conventional constant current control method to demonstrate the effectiveness of power balancing control embodiments in output voltage ripple reduction in the presence of unbalanced conditions.

As used herein, the term “substantially” means that the recited characteristic, parameter, and/or value need not be achieved exactly, but that deviations or variations, including for example, tolerances, measurement error, measurement accuracy limitations and other factors known to those of ordinary skill in the art may occur in amounts that do not preclude the effect the characteristic was intended to provide. A characteristic or feature that is substantially reduced or removed (e.g., the double line frequency (e.g., 120 Hz) ripple in the three-phase converter output voltage) may be eliminated or significantly reduced or minimized so that it is within the noise, beneath background, below detection capabilities, or of no consequence in a practical application.

Embodiments are described herein with respect to eliminating or substantially reducing output voltage ripple of three phase converters. However, it will be appreciated that by eliminating or substantially reducing output voltage ripple any ripple in output power is also eliminated or substantially reduced.

### I. Effect of Grid Voltage Imbalance in Phase-Modular Three-Phase Single-Stage AC-DC Converter

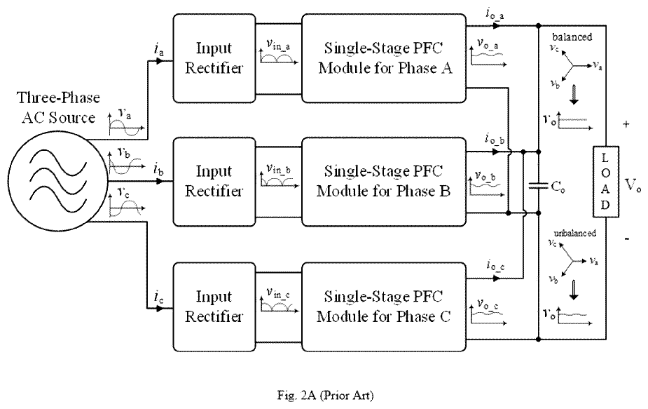

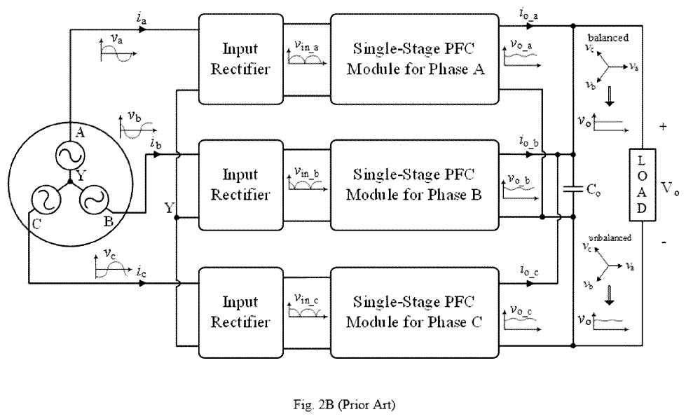

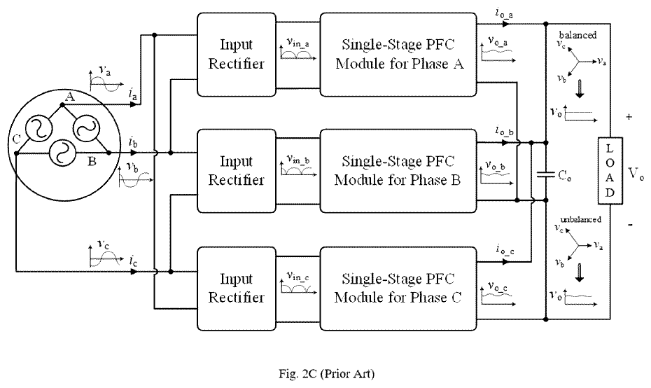

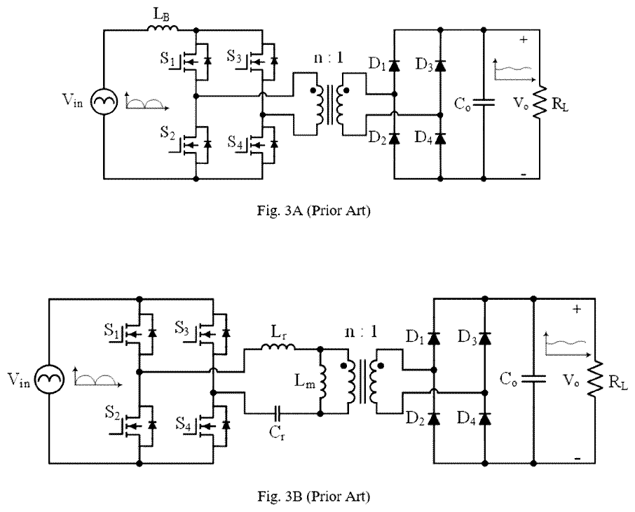

FIG. 2A shows the general structure of a phase-modular three-phase single-stage AC-DC converter. Both duty cycle controlled Pulse Width Modulated (PWM) converter modules and frequency controlled Pulse Frequency Modulated (PFM) converter modules can be used in phase-modular three-phase single-stage AC-DC converters. FIG. 2B shows a typical Y (or wye) connection of three-phase AC voltage where the phase voltage is applied to each single stage PFC module. FIG. 2C shows a typical Delta connection of three-phase AC voltage when the line-to-line voltage is applied to each single stage PFC module. Throughout this disclosure a Y connection is used to describe embodiments. However, it will be appreciated that the disclosure is also applicable to Delta connected three-phase AC voltage, and embodiments may be implemented accordingly. FIG. 3A shows an isolated Boost converter as an example of a PWM converter module and FIG. 3B shows an LLC resonant converter as an example of a PFM converter module. Converter modules may also be implemented with other designs such as, but not limited to, dual active bridge (DAB) converter, LCLC converter, active clamp boost converter, flyback converter, SEPIC converter, Zeta converter, and Cuk converter. Since the impact of unbalanced input voltage is similar for any single-stage PFC module, in the rest of this disclosure an LLC resonant converter module will be used as an example, however it will be appreciated that embodiments are not limited thereto.

Referring to FIG. 2A, the rectified AC voltage on each phase (V_{in_j} where j=a, b, c) feeds the primary side of the PFC module and the output voltage of each phase (V_{o_j} where j=a, b, c) has a DC voltage with a double line frequency ripple component when they operate alone. As shown in FIG. 2A, when the output of the three PFC modules are connected together, the double line frequency ripple components contained in the output of each PFC module are cancelled. As mentioned above, the structure of phase-modular three-phase AC-DC converters benefits from low output voltage ripple without double line frequency, so a large electrolytic capacitor is not required and the reliability of the AC to DC rectifier is significantly improved. However, if the input voltage is unbalanced then the double line frequency ripple components contained in the output of each PFC module are not cancelled and a double line frequency ripple appears in the output voltage, which is undesirable.

Assuming a pure sinusoidal current with a unity power factor for each phase, the voltage and current of the three-phase system can be written as follows.

$$\{ \begin{matrix}{v}_{a} = \sqrt{2} {V}_{a} sin ( ω t ) \\ {v}_{b} = \sqrt{2} {V}_{b} sin ( ω t - 120 ° ) \\ {v}_{c} = \sqrt{2} {V}_{c} sin ( ω t + 120 ° )\end{matrix} \qquad ( 1 )$$

$$\{ \begin{matrix}{i}_{a} = \sqrt{2} {I}_{a} sin ( ω t ) \\ {i}_{b} = \sqrt{2} {I}_{b} sin ( ω t - 120 ° ) \\ {i}_{c} = \sqrt{2} {I}_{c} sin ( ω t + 120 ° )\end{matrix} \qquad ( 2 )$$

where Vₐ, V_{b} and V_{c} are the RMS value of grid voltages, Iₐ, I_{b} and I_{c} are the RMS value of AC input currents and ω is the angular frequency. The RMS current is the same for balanced input current condition, i.e. Iₐ=I_{b}=I_{c}=I, and Vₐ≠V_{b}≠V_{c} for unbalanced grid voltages. Analysis of the creation of double-line frequency in total output current and voltage is provided as follows. The instantaneous three-phase input power can be calculated using (1) and (2) for unbalanced grid conditions.

$${P}_{3 ph} = {v}_{a} \times {i}_{a} + {v}_{b} \times {i}_{b} + {v}_{c} \times {i}_{c} = {P}_{in} + {P}_{2 ω} cos ( 2 ω t ) \qquad ( 3 )$$

In the above equation, Pᵢₙ is the average input power and P_{2ω} is the amplitude of the double line frequency of pulsating power that is expressed in (4) and (5), respectively.

$${P}_{i n} = {V}_{a} I + {V}_{b} I + {V}_{c} I \qquad ( 4 )$$

$${P}_{2 ω} cos ( 2 ω t ) = - {V}_{a} I cos ( 2 ω t ) - {V}_{b} I cos ( 2 ω t - 240 ° ) - {V}_{c} I cos ( 2 ω t + 240 ° ) \qquad ( 5 )$$

The rectified current in each phase has an average value plus a high-frequency term. Assuming the switching frequency is very high, and the switching frequency related energy stored in the output capacitor is negligible, then the instantaneous input power is equal to the instantaneous output power for a lossless circuit. Hence, the high-frequency term of the rectified current is neglected, and the average output current of each phase can be written as follows.

$${i}_{o \_ a} = \frac{{v}_{a} {i}_{a}}{{V}_{o}} , {i}_{o \_ b} = \frac{{v}_{b} {i}_{b}}{{V}_{o}} , {i}_{o \_ c} = \frac{{v}_{c} {i}_{c}}{{V}_{o}} \qquad ( 6 )$$

where Vₒ is the average output voltage that is considered to be DC. Hence, the instantaneous output current which is the sum of three-phase output currents can be expressed as follows.

$${i}_{o} = {i}_{o\_a} + {i}_{o \_ b} + {i}_{o \_ c} = {I}_{o} + {I}_{2 ω} cos ( 2 ω t ) \qquad ( 7 )$$

In the above equation, Iₒ is the average output current (DC part) and I_{2ω} is the amplitude of the double line frequency of pulsating current that is expressed in (8) and (9),respectively.

$${I}_{o} = \frac{{V}_{a} I}{{V}_{o}} + \frac{{V}_{b} I}{{V}_{o}} + \frac{{V}_{c} I}{{V}_{o}} \qquad ( 8 )$$

$${I}_{2 ω} cos ( 2 ω t ) = - \frac{{V}_{a} I}{{V}_{o}} cos ( 2 ω t ) - \frac{{V}_{b} I}{{V}_{o}} cos ( 2 ω t - 120 ° ) - \frac{{V}_{c} I}{{V}_{o}} cos ( 2 ω t + 240 ° ) \qquad ( 9 )$$

In the above equation, if the amplitude of three-phase input voltages is not the same, the double line frequency pulsating current term cannot be cancelled, and hence the output current and output voltage will have the double line-frequency ripple.

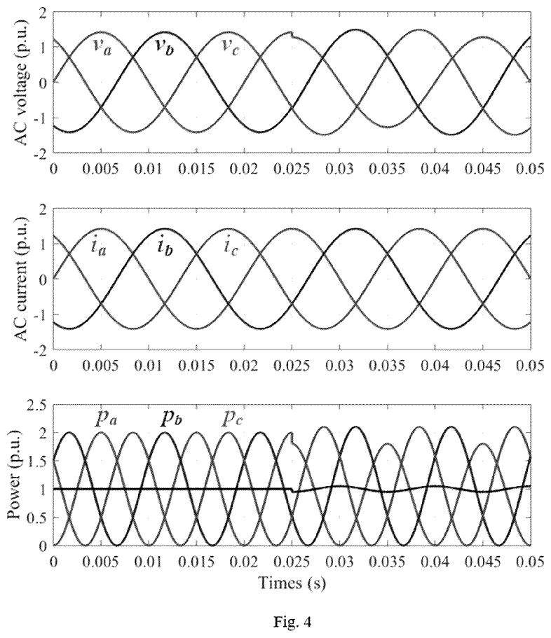

FIG. 4 illustrates the input AC voltages (vₐ, v_{b}, v_{c}), AC currents (iₐ, i_{b}, i_{c}), and instantaneous power of each phase (pₐ, p_{b}, p_{c}) as well as total three-phase power (pₒ) for an unbalanced condition with an initially balanced operation. FIG. 4 also shows a 10% step decrease in the voltage of phase A and a 5% increase in the voltage of phases B and C that occurred at 25 ms. As can be observed in the instantaneous power, as soon as the input voltages are unbalanced (at 25 ms) a pulsating power is generated in the three-phase system that transfers to the load.

### II. Control Strategy for PFC and Power Balancing

As discussed in the previous section, any imbalance in the amplitude of the voltage of the three input sources leads to the presence of a double line frequency ripple in the output of a modular three-phase AC-DC converter. As described herein, to cancel out the double line frequency ripple in the output current, the current reference of each phase should change such that the multiplication of each phase voltage and current are identical in all terms of equation (9), so the fluctuating current at double line frequency can be cancelled. According to some embodiments, the change in current of a phase may be achieved by changing the instantaneous power of that phase. For example, if one phase voltage is reduced, its current automatically increases. Ignoring the power losses of the converters, the average input power is equal to the average output power in each phase (P_{in_j}=P_{o_j} where j=a, b, c), so the relationship between the instantaneous input power and average output power in each phase can be written as follows.

$$\{ \begin{matrix}{p}_{in \_ a} = {P}_{o \_ a} ( 1 - cos ( 2 ω t ) ) \\ {p}_{in \_ b} = {P}_{o \_ b} ( 1 - cos ( 2 ω t - 240 ) ) \\ {p}_{in \_ c} = {P}_{o \_ c} ( 1 - cos ( 2 ω t + 240 ) )\end{matrix} \qquad ( 10 )$$

Considering a pure sinusoidal grid voltage, if the input power of each phase is controlled to satisfy (10), a high power factor can be achieved in each phase and at the same time the average output power of each phase will be indirectly controlled to be identical in all three phases (i.e. P_{o_a}=P_{o_b}=P_{o_c}=Pₒ/3). In the outer voltage control loop, the output of the proportional integral (PI) compensator is a power control signal (P_{ctrl}) that regulates the output voltage level. Then the reference power for each phase can be expressed as follows.

$$\{ \begin{matrix}{p}_{ref \_ a} = {P}_{ctrl} ( 1 - cos ( 2 ω t ) ) \\ {p}_{ref \_ b} = {P}_{ctrl} ( 1 - cos ( 2 ω t - 240 ° ) ) \\ {p}_{ref \_ c} = {P}_{ctrl} ( 1 - cos ( 2 ω t + 240 ° ) )\end{matrix} \qquad ( 11 )$$

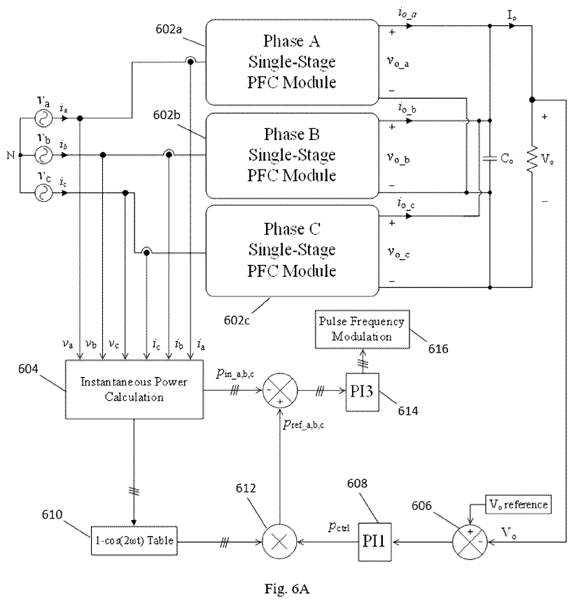

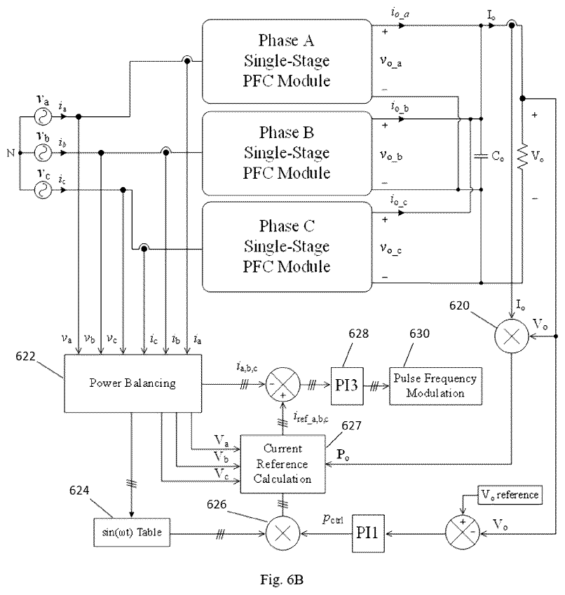

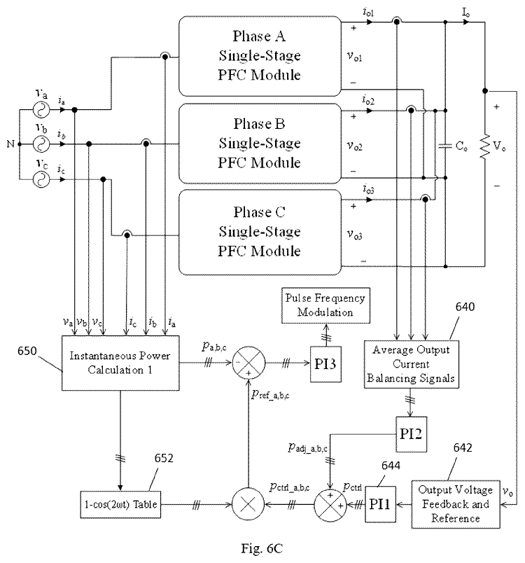

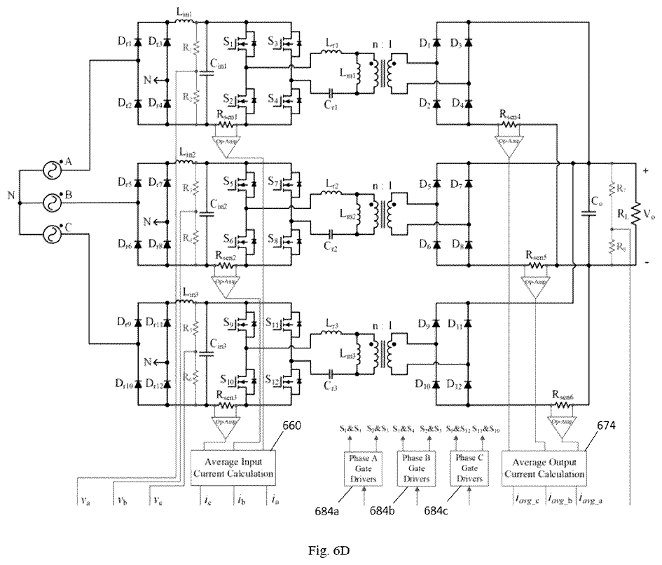

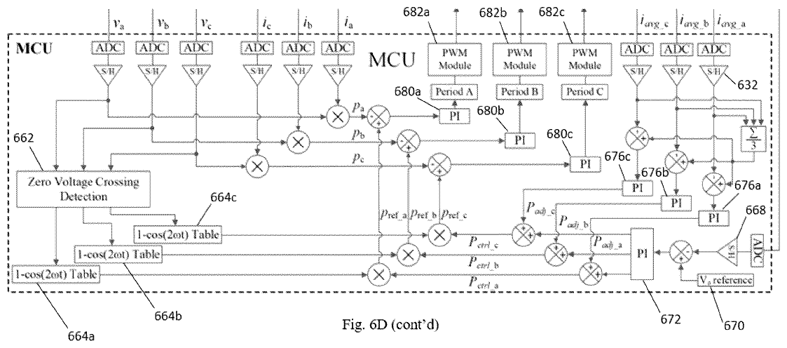

FIG. 6A shows a control block diagram that implements a control strategy according to one embodiment, based on equation (11). In the figure, an instantaneous power calculator 604 calculates the instantaneous input power of the converter module 602a, 602b. 603c of each phase, as shown below:

$$\{ \begin{matrix}{p}_{in \_ a} = {v}_{a} \times {i}_{a} \\ {p}_{in \_ b} = {v}_{b} \times {i}_{b} \\ {p}_{in \_ c} = {v}_{c} \times {i}_{c}\end{matrix} \qquad ( 11.1 )$$

$${P}_{in} = {p}_{in \_ a} + {p}_{in \_ b} + {p}_{in \_ c}$$

As shown in FIG. 6A, the output voltage Vₒ of the three-phase converter is sensed and compared to a reference voltage Vₒ reference at 606, and then a controller 608 (e.g., a PI controller) is used to generate a power control signal petri. An output of the instantaneous power calculator 604 is used to determine a feature (e.g., a value(1-cos(2ωt))) using e.g., a look-up table 610, which is multiplied with the power control signal p_{ctrl} at 612 to generate a power reference signal p_{ref_a,b,c}. According to this embodiment, the instantaneous input power p_{in_j} (j=a, b, c) follows the reference input power p_{ref_j} (j=a, b, c) as given in equation (11). A controller 614 (e.g., a PI controller) forces the instantaneous input power, as expressed in equation (11.1), to follow the reference input power, as expressed in equation 11. Other controllers, such as PID (proportional-integral-differential) controller or QR (quasi-resonant) controllers can also be used. The output of the controller 614 is used by a modulation block 616 to generate drive signals for the switching devices of the three single-phase PFC modules 602a, 602b. 603c.

Under steady state, the output power may be used to calculate the reference current for each phase as shown in equation (11.2) below and the input AC current in each phase will follow the reference current by controller 614.

$$\{ \begin{matrix}{i}_{ref \_ a} = {P}_{ctrl} \times \frac{{P}_{o}}{3 {V}_{a}} sin ( ω t ) \\ {i}_{ref \_ b} = {P}_{ctrl} \times \frac{{P}_{o}}{3 {V}_{b}} sin ( ω t - 120 ° ) \\ {i}_{ref \_ c} = {P}_{ctrl} \times \frac{{P}_{o}}{3 {V}_{c}} sin ( ω t + 120 ° )\end{matrix} \qquad ( 11.2 )$$

$${P}_{o} = {V}_{o} \times {I}_{o}$$

FIG. 6B shows a control block diagram according to another embodiment to implement a control strategy to control the instantaneous input current of each phase based on equation (11.2), where the instantaneous input current reference is calculated based on output power Pₒ and input AC voltage. As shown in FIG. 6B, this embodiment includes some of the features of the embodiment of FIG. 6A. However, as shown in FIG. 6B, the output current Iₒ of the three-phase converter is sensed and multiplied 620 with the sensed output voltage Vₒ to determine the output power Po which is the input to the current reference calculator 627 to generate the instantaneous input current reference signal i_{ref_a,b,c} according to equation (11.2). Va, Vb, and Vc are the rms values of the phase voltages, which are calculated in the power balancing block 622. A power control signal p_{ctrl} is generated similarly to the embodiment of FIG. 6A, and an output of the power balancing block 622 is used to determine a feature (e.g., a value (sin(ωt))) using e.g., a look-up table 624, which is multiplied with the power control signal Petri at 626, which is used by the current reference calculator 627 to generate the input current reference signal i_{ref_a,b,c} according to equation (11.2). A controller (e.g., a PI controller) 628 forces the instantaneous input current, as expressed in equation (11.2), to follow the reference input current. The output of the controller 628 is used by a modulation block 630 to generate drive signals for the switching devices of the three single-phase PFC modules. If the power loss that occurrs in each phase of the three-phase modules is not identical, the output power share between the three phases cannot be balanced with identical power control signals (i.e., P_{o_a}≠P_{o_b}≠P_{o_c}), as shown in equation (10). In this case a feedback loop may be used to adjust the power control signal for each phase. To achieve this, the average output current of each phase may be sensed, calculated, and compared to the average value of the three output currents. FIG. 6C shows a control block diagram according to one embodiment to implement this control strategy. This embodiment includes some of the features of the embodiment of FIG. 6A. In FIG. 6C, i_{o_a}=iₒ₁, i_{o_b}=iₒ₂, i_{o_c}=iₒ₃ are the instantaneous output current values for each phase. Assume I_{o_a}, I_{o_b}, I_{o_c} are the calculated average output current values of each phase. Then:

$$Io\_avg = ( Io\_a + Io\_b + I oc ) / 3 \qquad ( 11.3 A )$$

$$Delta\_Io \_a = Io\_avg - Io\_a \qquad ( 11.3 B )$$

$$Delta\_Io \_b = Io\_avg - Io\_b \qquad ( 11.3 C )$$

$$Delta\_Io \_c = Io\_avg - Io\_c \qquad ( 11.3 D )$$

The offset power for each phase may be calculated as:

$$Padj\_a = Delta\_Io \_a * Vo \qquad ( 11.4 A )$$

$$Padj\_b = Delta\_Io \_b * Vo \qquad ( 11.4 B )$$

$$Padj\_c = Delta\_Io \_c * Vo \qquad ( 11.4 C )$$

In the embodiment of FIG. 6C, an average output current balancing block 640 performs the above calculation. The calculated output power adjustment p_{adj_a,b,c} is added to the power control signal, p_{ctrl}, i.e., the output of the output voltage controller 642 which may be implemented as in the embodiment of FIG. 6A. After compensation, e.g., a PI controller 644, p_{ctrl} may be used with power adjust control signals for each phase (P_{adj_j} where j=a, b, c) to generate power control signals p_{ctrl_a,b,c}. for each phase. Similarly to the embodiment of FIG. 6A, an output of the instantaneous power calculator 650 is used to determine a feature (e.g., a value(1-cos(2ωt))) using e.g., a look-up table 652, which is multiplied with the power control signal petri to generate a power reference signal p_{ref_a,b,c}. Hence, (11) can be rewritten as follows considering the output current feedback control loop.

$$\{ \begin{matrix}{p}_{ref \_ a} = {P}_{ctrl \_ a} ( 1 - cos ( 2 ω t ) ) \\ {p}_{ref \_ b} = {P}_{ctrl \_ b} ( 1 - cos ( 2 ω t - 240 ° ) ) \\ {p}_{ref \_ c} = {P}_{ctrl \_ c} ( 1 - cos ( 2 ω t + 240 ° ) )\end{matrix} \qquad ( 12 )$$

where P_{ctrl_a}, P_{ctrl_b} and P_{ctrl_c} are new control signals with a feedback loop that are defined as follows.

$$\{ \begin{matrix}{P}_{ctrl \_ a} = {P}_{ctrl} + {P}_{adj \_ a} \\ {P}_{ctrl \_ b} = {P}_{ctrl} + {P}_{adj \_ b} \\ {P}_{ctrl \_ c} = {P}_{ctrl} + {P}_{adj \_ c}\end{matrix} \qquad ( 13 )$$

As shown in FIG. 6C, p_{adj_j} (j=a, b, and c) is the error between the actual output power and the average output power of phase a, phase b and phase c. Hence, by adding the feedback loop the instantaneous output current of each phase results in the pulsating terms of the output current being canceled out, which consequently removes line frequency ripple from the output voltage. Moreover, a near unity power factor may be achieved by the strategy shown in FIG. 6C as the input power is controlled to follow the reference power as in equation (12), which is true as long as a pure sinusoidal voltage is available at the grid side. With a control strategy according to the embodiment as shown in equations (12), (13), the output power of each phase is controlled to be substantially the same.

In the above description it was assumed that the AC input voltage is pure sinusoidal, and no harmonics are present. If the AC input voltage contains harmonics, instantaneous power balancing control strategy, as described in equation (11) and equation (12) will still work. In this case, harmonics will also be present in the AC input current of each phase. The AC harmonic current will significantly reduce the double line frequency component at the output, as described below. Since in an actual implementation the harmonic components of the AC voltage are very small, the harmonics of the AC current are also very small.

If the input voltage has harmonics, then depending on the amount of voltage distortion the maximum achievable power factor will be below unity. The maximum amount of allowable total harmonic distortion (THD) for general purposes is 5% based on IEEE 519-1992 standard [16]. The input AC voltages can be represented as follows if some harmonics are considered (e.g., 3^{rd} and 5^{th}, etc.).

$$\{ \begin{matrix}{v}_{a} = \sqrt{2} {V}_{a 1} sin ( ω t ) + \sqrt{2} {V}_{a 3} sin ( 3 ω t ) + \sqrt{2} {V}_{a 5} sin ( 5 ω t ) + … \\ \begin{matrix}{v}_{b} = \sqrt{2} {V}_{b 1} sin ( ω t - 12 {0}^{∘} ) + \sqrt{2} {V}_{b 3} sin ( 3 ω t ) + \\ \sqrt{2} {V}_{b 5} sin ( 5 ω t + 120 ° ) + …\end{matrix} \\ \begin{matrix}{v}_{c} = \sqrt{2} {V}_{c 1} sin ( ω t + 12 {0}^{∘} ) + \sqrt{2} {V}_{c 3} sin ( 3 ω t ) + \\ \sqrt{2} {V}_{c 5} sin ( 5 ω t - 120 ° ) + …\end{matrix}\end{matrix} \qquad ( 14 )$$

where Vⱼ₁, Vⱼ₃ and Vⱼ₅ (j=a, b, c) are the RMS values of the first, third, and fifth voltage harmonics, respectively. To compare the instantaneous power with the reference signal that has a DC component plus a double line frequency component, the multiplication of three-phase voltages and currents should have only the mentioned two components as shown in (3). A solution that allows higher-order harmonics cancellation in instantaneous power is that the resulting input current has the same harmonics content as in the grid voltage, but with the opposite sign. Hence, in one embodiment of the power-controlled PFC, the resulting current waveforms considering harmonics presented in (14) may be as follows.

$$\{ \begin{matrix}{i}_{a} = \sqrt{2} {I}_{a 1} sin ( ω t ) - \sqrt{2} {I}_{a 3} sin ( 3 ω t ) - \sqrt{2} {I}_{a 5} sin ( 5 ω t ) - … \\ \begin{matrix}{i}_{b} = \sqrt{2} {I}_{b 1} sin ( ω t - 12 {0}^{∘} ) - \sqrt{2} {I}_{b 3} sin ( 3 ω t ) - \\ \sqrt{2} {I}_{b 5} sin ( 5 ω t + 12 {0}^{∘} ) - …\end{matrix} \\ \begin{matrix}{i}_{c} = \sqrt{2} {I}_{c 1} sin ( ω t + 12 {0}^{∘} ) - \sqrt{2} {I}_{c 3} sin ( 3 ω t ) - \\ \sqrt{2} {I}_{c 5} sin ( 5 ω t - 12 {0}^{∘} ) - …\end{matrix}\end{matrix} \qquad ( 15 )$$

where Iⱼ₁, Iⱼ₃ and Iⱼ₅ (j=a, b, c) are the RMS values of the first, third, and fifth current harmonics, respectively.

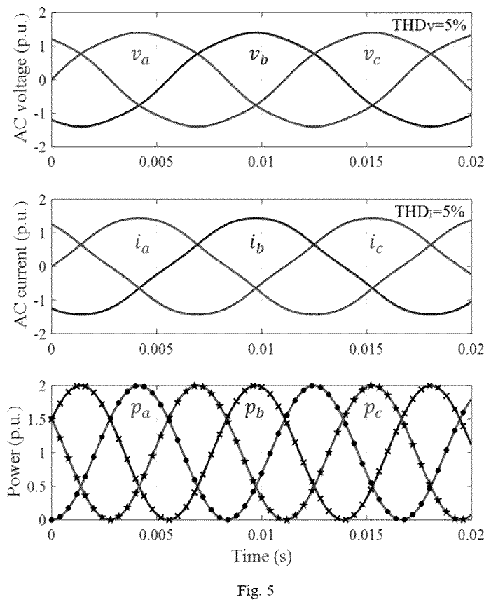

FIG. 5 illustrates the per unit representation of three-phase input voltages (upper panel) with the addition of some odd harmonics totaling 5% THD as well as input currents (middle panel) with the same harmonic content with opposite sign. The resulting instantaneous power (lower panel) is shown with solid lines and the markers are from plotting (10). It can be seen that the markers are aligned on the solid lines, which confirms that only double line frequency has remained in the instantaneous power. When the output voltages of these three phases are added together, the double line frequency voltage is cancelled and only a pure DC voltage remains.

With constant power control, if there is any harmonic in grid voltages there will be the same harmonic content with the negative sign in the current. As defined, THD is the ratio of the square root of the sum of the RMS value square of all harmonic components over the RMS value square of the first harmonic, which is insensitive to the sign of harmonics. Hence, the same amount of THD in AC voltage is projected in the AC current as well. It should be mentioned that the PFC converter itself may have some current distortion in different scenarios that are not considered here. Hence, considering perfect PFC performance for the AC-DC converter, the maximum achievable power factor with constant power control in the presence of harmonics in the grid voltages may be calculated as follows.

$$PF = \frac{1}{1 + {THD}_{V}^{2}} \qquad ( 16 )$$

With 5% THD in grid voltages, the maximum achievable power factor would be 0.9975. In comparison, with constant current control, the maximum achievable power factor would be 0.9987. As long as PFC operation of the AC-DC converter is near unity and the grid voltage harmonic content are within standards, the difference in power factor due to voltage harmonics is negligible between the power control method embodiments and the conventional constant current control method. That is, the power factor will still be high enough to meet the standard requirements.

FIG. 6D shows a detailed circuit level digital implementation of FIG. 6C, according to one embodiment, in this case a phase-modular three-phase LLC AC-DC converter. In the figure, Lin1, Cin1, Lin2, Cin2 and Lin3, Cin3 are high frequency filters that remove the switching frequency noise. They do not impact the power balancing operation.

It is noted that any suitable technology may be used to implement control strategy embodiments presented herein, such as, for example, a digital signal controller (DSC), a digital controller such as a microcontroller unit (MCU), a field programmable gate array (FPGA), etc., as well as combinations of digital and analogue circuits. In FIG. 6D an MCU is shown.

Referring to FIG. 6D, the input current of each LLC resonant converter is sensed through a sensing resistor (Rₛₑₙ₁, Rₛₑₙ₂, Rₛₑₙ₃) and the instantaneous input current is used by an average input current calculator 660 to calculate the average input current iₐ, i_{b}, i_{c} in each switching cycle, which is then multiplied with the sampled input voltage vₐ, v_{b}, v_{c} of each phase to calculate the instantaneous input power pₐ, p_{b}, p_{c}.

To generate the reference power signals p_{refa}, p_{refb}, p_{refc}, a 1-cos(2ωt) look-up table e.g., 664a, 664b, 664c is called starting at the voltage zero-crossing points 662 of the input voltages. The three-phase converter output voltage is sampled 668 and compared to a reference voltage 670 and then is passed through a digital PI compensator 672 to generate the proper amplitude of power control signals for each phase (P_{ctrl_j} where j=a, b, c) that are multiplied with the respective 1-cos(2ωt) term for each phase. Therefore, three independent time-varying reference power signals (P_{ref_j} where j=a, b, c are generated based on the input power of each phase that can be compared with the sensed instantaneous input power signals pₐ, p_{b}, p_{c}.

In the feedback power balancing loop, three adjusting power signals (P_{adj_j} where j=a, b, c) are generated to fine-tune the output power balancing. The sensed output currents are averaged over a half-line cycle by an average output current calculator 674. Then, the output current of each phase is compared to the average value of three-phase currents, which after passing through three individual digital PI compensators 676a, 676b, 676c that are slower than the other control loops provide the proper adjusting power signals for each phase. Then, the adjusting power signals (P_{adj}) are summed with the power control signal (P_{ctrl}) from the voltage loop to allow accurate power balancing even with unbalanced three-phase modules. The resulting time-variant power reference signals (p_{ref_j} where j=a, b, c) are compared to the respective instantaneous input power pₐ, p_{b}, p_{c} of each phase and then pass through three digital PI compensators 680a, 680b, 680c to generate a proper control signal (i.e., a period or switching period for a frequency-controlled PFM converter as shown in the embodiments of FIG. 6A-6C and a duty cycle for a PWM converter) for the PWM modules 682a, 682b, 682c for each phase, which then generate the gate drive signals 884a, 684b, 684c for the converter switching devices (which may be MOSFETs, IGBTs, HEMTs, etc.). It is noted that the PWM modules (682a, 682b, 682c) may be implemented in an MCU. It generates a frequency signal for PFM controlled converters, such as an LLC converter, or a PWM signal for PWM controlled converters, such as an isolated Boost converter. In FIG. 6D, period A, period B, and period C indicate the required switching period (equivalent to switching frequency) for these three phase converters at a specific time. Hence, according to embodiments, there is a voltage loop to realize output voltage regulation, and there are three current balancing feedback loops to make sure that the output power is effectively balanced, and each phase has its inner power control loop to realize PFC operation. As discussed above, a balanced power may be achieved in each phase at the same time with power factor correction. Hence, the dynamic of the system is fast, and the double line frequency output voltage ripple will not be large even during transients.

### III. Example: Simulation and Experimental Results

A simulation model of an embodiment was implemented with a three-phase single-stage LLC AC-DC converter in PSIM software (Powersim Inc., Troy, MI, U.S.A.) and a laboratory prototype with digital control implementation was built for practical verification. A list of the parameters used in both simulation and experimental setups is provided in Table I.

TABLE I
Parameters used in the simulation and prototype.

| | Parameter | | Value | |
|---|---|---|---|---|
| Rated Output Power (Pₒ) | | | 1.5 | kW |
| AC Voltage (Vₐ, V_{b}, V_{c}) | | | 220 | V_{RMS} |
| Maximum DC Output Voltage (Vₒ) | | | 380 | V |
| Switching Frequency (fₛ) | | | 200 kHz-350 kHz | |
| Parallel Resonant Inductor (Lₘ) | | | 120 | μH |
| Series Resonant Inductor (Lᵣ) | | | 23 | μH |
| Series Resonant Capacitor (Cᵣ) | | | 4.2 | nF |
| Transformer Turns Ratio (Nₚ:Nₛ) | | | 24:17 | |
| | Input Filter | Inductor | 15 | μH |

| (Lᵢₙ₁, Lᵢₙ₂, Lᵢₙ₃) | | |
|---|---|---|
| Capacitor | 0.5 | μF |

(Cᵢₙ₁, Cᵢₙ₂, Cᵢₙ₃)

| | | |
|---|---|---|
| Output Capacitor (Cₒ) | 60 | μF |

It is noted that the 60 μF output capacitor value is very small for 1,500 W (380 V, 4 A) AC-DC rectifier application. The results shows that even with such a small capacitor value, the double line frequency ripple is very small, and may be considered to be negligible. In an actual implementation a small capacitor should be used as good engineering practice for noise removal, impedance matching, etc.

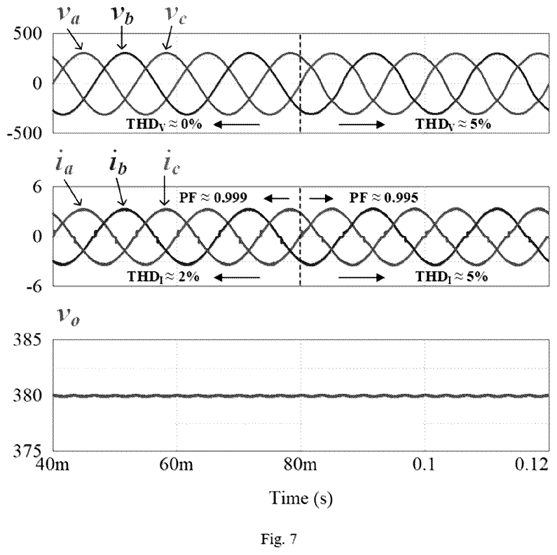

In order to see the effect of grid voltage harmonics on the power factor performance of the embodiment, odd harmonics (i.e., 3^{rd}, 5^{th}, and 7^{th}) were injected into the three-phase input voltages. FIG. 7 shows the simulation results with a pure three-phase sinusoidal voltage before 80 ms and with 5% THD after 80 ms. The measured power factor before 80 ms was 0.999 and the power factor after 80 ms was 0.995, which are very close and near-unity power factor, confirming the effectiveness of the embodiment of the power control method even with harmonics in the grid voltages. Moreover, the input voltage harmonics do not have any effect on the output voltage ripple. That is, the simulated output double line frequency ripple was very small, considering that a relatively small (60 μF) capacitor was used at the output and the output power was 1,500W, with 380V and 4 A.

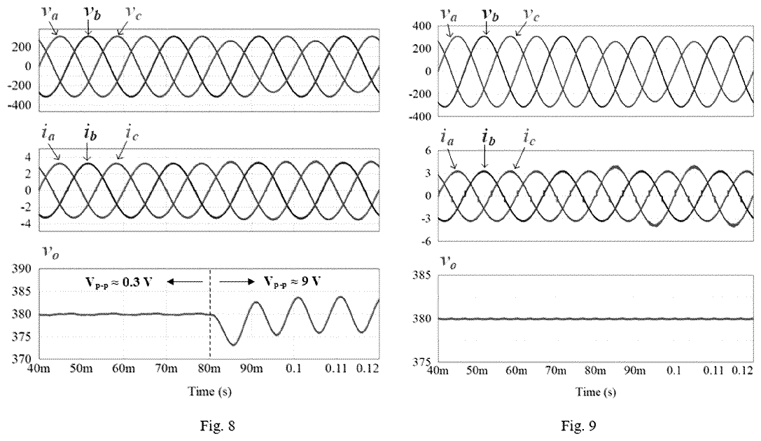

To observe the double line frequency output voltage ripple, first, a simulation was done using a conventional approach with a constant current reference for all phases. In the simulation, only a 15% decrease was considered for Vₐ. FIG. 8 shows the input voltage and current for all three phases as well as the output voltage of the converter. The measured power factor in the simulation is close to unity (i.e., >0.999) with THD of less than 2% in the input current and all phases have the same good performance. Moreover, before 80 ms when the input voltages are balanced, the output voltage ripple is small (i.e., ˜300 mV) and there is no double line frequency ripple until the point that a step change has occurred in the input voltage. The double line frequency ripple appears in the output voltage as soon as the input voltages get unbalanced due to the step change occurring at 80 ms. The peak-to-peak voltage ripple is as big as 9 V which is 30 times larger than the balanced input voltage condition, which requires 30 times larger output capacitance to keep the output voltage ripple as low as with balanced grid voltages.

FIG. 9 shows the simulation results with an embodiment of the power balancing control strategy. As can be seen, with both balanced and unbalanced input voltage conditions there is no double line frequency in the output voltage ripple. In this simulation, the power balancing control strategy described in equation (11) was used. The power loss of each converter was neglected. The output voltage waveform shown at the bottom of FIG. 9 is zoomed-in, relative to the output voltage waveform in FIG. 8. As can be observed, with the embodiment even with large input voltage imbalance conditions there is no significant double line frequency ripple in the output voltage of the three-phase single-stage LLC AC-DC converter and the power factor remains near unity under unbalanced grid voltages.

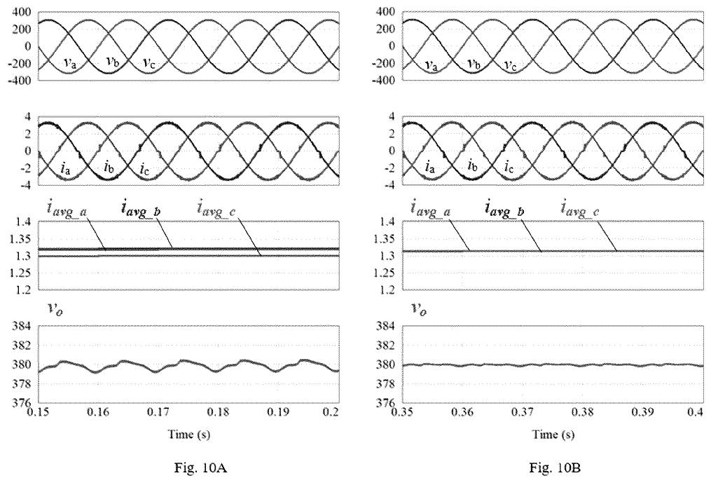

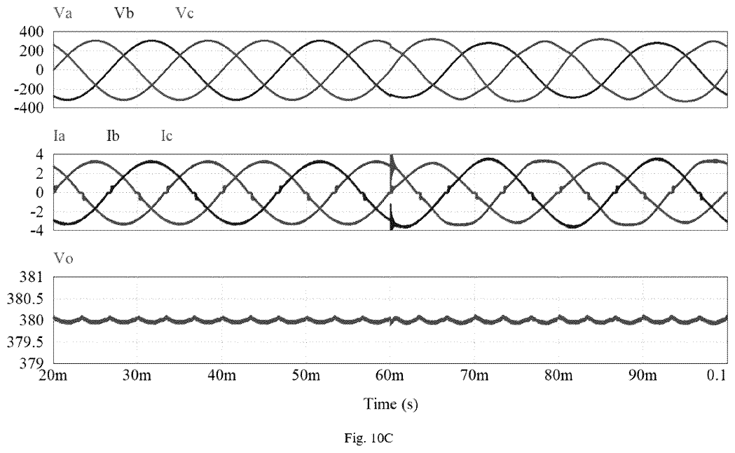

To explicitly see the effect of unbalanced power loss conditions between the three-phase modules, the power loss that occurred in phase C was deliberately increased such that the efficiency in phase C was around 5% lower than in the other two phases. It is noted that in practical applications, the efficiency difference between different PFC modules is very small, e.g., less than 0.5%. The simulation results of the power balancing control method without the power balancing feedback loop are shown in FIG. 10A. It can be seen that the sensed average output current of phase C is lower than the other two phases which is due to the higher power loss that occurred in that phase. Moreover, a slight double line frequency voltage ripple can be seen in the output voltage with a 1.2 V peak-to-peak ripple, which is due to the slightly unbalanced output power between the phases. In FIG. 10B the simulation results with a power balancing feedback loop according to an embodiment (equations 12, 13) are shown and it can be seen that the sensed average output current is balanced in all three phases, hence the double line frequency ripple is effectively removed by the feedback loop.

FIG. 10C shows the simulation results when (1) Va is 10% higher, Vb=Vb is 5% lower, (2) Va contains 5% third harmonics, Vb contains 3% third harmonics, Vc contains 3% fifth harmonics, and (3) control strategy of equation (11) is used. It is observed that no double line frequency ripple is present at the output voltage. The output voltage contains a very small 6th harmonic (360 Hz), around 0.2 V peak to peak. This demonstrates that the control strategy removes the double line frequency ripple under real application conditions.

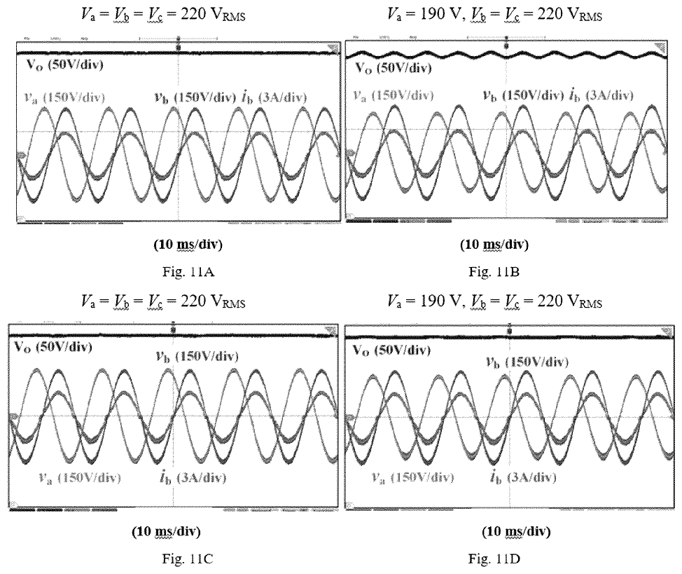

A prototype was built to validate the performance of an embodiment of the power balancing control method on output voltage ripple reduction using a three-phase LLC converter with parameters listed in Table 1. A digital controller was implemented with a low-cost dsPIC Microchip MCU (Microchip Technology Inc., Chandler, Arizona, USA). FIGS. 11A and FIG. 11B show the experimental results using conventional constant current control with balanced (Vₐ=V_{b}=V_{c}=220 V_{RMS}) and unbalanced (Vₐ=190 V, V_{b}=V_{c}=220 V_{RMS}) input voltages, respectively. As can be observed, there is substantially no double line frequency voltage ripple (close to zero) in the output voltage Vₒ with balanced input voltages, however, with unbalanced input voltages, there is a relatively large double line frequency voltage ripple (around 20V peak to peak) in the output voltage of the AC-DC converter. FIG. 11C and FIG. 11D show the experimental results for the embodiment of the power balancing control with both balanced (Vₐ=V_{b}=V_{c}=220 V_{RMS}) and unbalanced (Vₐ=190 V, V_{b}=V_{c}=220 V_{RMS}) input voltages, respectively. As can be observed, with both balanced and unbalanced input voltages the output voltage ripple is very small without double line frequency voltage ripple.

It will be appreciated that the power balancing control strategies described herein may also be applied to Delta connected three phase systems, wherein the input voltage of the PFC modules is the line voltage.

In summary, control strategy embodiments presented herein for phase-modular three-phase single-stage AC-DC converters with simultaneous power factor correction and power balancing features substantially cancel out double line frequency ripple in the output voltage that is caused by an imbalance in the input voltages. According to embodiments, the output capacitance of the three-phase AC-DC converter can be small even in the presence of unbalanced input voltages and power losses. A high-power factor (i.e., >0.99) may be achieved with the power balancing control embodiments in both balanced and unbalanced input voltage conditions with and without input voltage harmonics.

All cited documents are incorporated herein by reference in their entirety.

### EQUIVALENTS

Those of ordinary skill in the art will recognize, or be able to ascertain through routine experimentation, equivalents to the embodiments described herein. Such equivalents are within the scope of the invention and are covered by the appended claims.

### REFERENCES

[1] H. M. Suryawanshi, M. R. Ramteke, K. L. Thakre and V. B. Borghate, “Unity-Power-Factor Operation of Three-Phase AC-DC Soft Switched Converter Based On Boost Active Clamp Topology in Modular Approach,” IEEE Trans. Power Electron, vol. 23, no. 1, pp. 229-236, Jan. 2008.
[2] B. Tamyurek and D. A. Torrey, “A Three-Phase Unity Power Factor Single-Stage AC-DC Converter Based on an Interleaved Flyback Topology,” IEEE Trans. Power Electron., vol. 26, no. 1, pp. 308-318, Jan. 2011.
[3] G. Tibola and I. Barbi, “Isolated Three-Phase High Power Factor Rectifier Based on the SEPIC Converter Operating in Discontinuous Conduction Mode,” IEEE Trans. Power Electron., vol. 28, no. 11, pp. 4962-4969 Nov. 2013.
[4] B. Singh, S. Singh and G. Bhuvanwswari, “Analysis and Design of a Zeta Converter Based Three-Phase Switched Mode Power Supply,” in Proc. International Conference on Computational Intelligence and Communication Networks, Mathura, 2012, pp. 571-575.
[5] S. Gangavarapu, A. K. Rathore and D. M. Fulwani, “Three-Phase Single-Stage-Isolated Cuk-Based PFC Converter,” IEEE Trans. Power Electron., vol. 34, no. 2, pp. 1798-1808 Feb. 2019.

[6] G. Bhuvaneswari, S. Narula and B. Singh, “Three-phase push-pull modular converter based welding power supply with improved power quality,” in Proc. India International Conference on Power Electronics (IICPE), Delhi, 2012, pp. 1-5.
[7] Y. K. E. Ho, S. Y. R. Hui and Yim-Shu Lee, “Characterization of single-stage three-phase power-factor-correction circuit using modular single-phase PWM DC-to-DC converters,” IEEE Trans. Power Electron., vol. 15, no. 1, pp. 62-71, Jan. 2000.
[8] J. Lu, K. Bai, A. R. Taylor, G. Liu, A. Brown, P. M. Johnson and M. McAmmond, “A Modular-Designed Three-Phase High-Efficiency High-Power-Density EV Battery Charger Using Dual/Triple-Phase-Shift Control,” IEEE Trans. Power Electron., vol. 33, no. 9, pp. 8091-8100 Sep. 2018.
[9] M. Forouzesh, Y.-F. Liu and P. C. Sen, “Implementation of an Isolated Phase-Modular-Designed Three-Phase PFC Rectifier Based on Single-Stage LLC Converter,” in Proc. ECCE, 2021, pp. 2266-2273.
[10] S. Bala, T. Tengner, P. Rosenfeld, and F. Delince, “The effect of low frequency current ripple on the performance of a lithium iron phosphate (LFP) battery energy storage system,” in Proc. IEEE Energy Conversion Congress Exposition (ECCE), Sep. 2012, pp. 3485-3492
[11] U. Kamnarn and V. Chunkag, “Analysis and design of a parallel and source splitting configuration using SEPIC modules based on power balance control technique,” in Proc. IEEE International Conference on Industrial Technology (ICIT), Hong Kong, 2005, pp. 1415-1420.
[12] U. Kamnarn and V. Chunkag, “Analysis and Design of a Modular Three-Phase AC-to-DC Converter Using CUK Rectifier Module With Nearly Unity Power Factor and Fast Dynamic Response,” IEEE Trans. On Power Electron., vol. 24, no. 8, pp. 2000-2012 Aug. 2009.
[13] R. Girod and D. Weida, “High Efficient True 3-Phase Compact Switch-Mode Rectifier Module for Telecom Power Solutions,” in Proc. IEEE International Telecommunications Energy Conference (INTELEC), SMART POWER AND EFFICIENCY, Hamburg, Germany, 2013, pp. 1-6.
[14] L. Huber, M. Kumar and M. M. Jovanovic, “Analysis, design, and evaluation of three-phase three-wire isolated ac-dc converter implemented with three single-phase converter modules,” in Proc. IEEE Applied Power Electronic Conference Exposition (APEC), Long Beach, CA, 2016, pp. 38-45.
[15] B. Kim, H. Kim and S. Choi, “Three-phase on-board charger with three modules of single-stage interleaved soft-switching AC-DC converter,” in Proc. IEEE Applied Power Electronic Conference Exposition (APEC), San Antonio, TX, 2018, pp. 3405-3410.
[16] IEEE 519 Working Group. “IEEE recommended practices and requirements for harmonic control in electrical power systems.” IEEE STD 519-1992, 1992.

1. A controller for a three phase power converter, comprising:
a first circuit that determines an instantaneous input power of each phase;
a feedback circuit that determines at least one power control signal based on an output of the three phase power converter;
a second circuit that uses the power control signal to adjust the instantaneous input power of each phase to achieve power balancing of the three phases;
wherein a double line frequency ripple in an output power of the three phase converter is substantially eliminated.

2. The controller of claim 1, wherein:
the first circuit senses an input current and an input voltage for each phase, and determines the instantaneous input power for each phase;
the feedback circuit senses an output voltage of the three phase converter and determines the power control signal for each phase;
the second circuit uses the power control signal for each phase together with a feature of the input voltage for each phase to determine a reference power signal for each phase, and compares the reference power signal for each phase to the instantaneous input power for each phase to generate a control signal for each phase;
an output circuit uses the control signal for each phase to generate drive signals for switching devices of power circuits of each phase of the three phase power converter to achieve the power balancing of the three phases.

3. The controller of claim 2, wherein the feature of the input voltage for each phase is determined according to 1-cos(2ωt).

4. The controller of claim 2, wherein the feedback circuit senses an output voltage and an output current of the three-phase converter;
wherein the controller uses the sensed output voltage to determine the power control signal for each phase, and uses the power control signal for each phase together with the feature of the input voltage for each phase to determine a reference current signal for each phase;
wherein the controller uses the sensed output current and voltage to determine an output power of the three-phase converter;
wherein the output power is used to determine an instantaneous input current of each phase that is used with the reference current signal for each phase to generate the control signal for each phase.

5. The controller of claim 4, wherein the feature of the input voltage for each phase is determined according to sin(ωt).

6. The controller of claim 2, wherein the feedback circuit senses the output voltage of the three phase converter and an output current of each phase to determine the power control signal for each phase, and uses the power control signal for each phase together with a feature of the input voltage for each phase to determine the reference power signal for each phase.

7. The controller of claim 6, wherein the feature of the input voltage for each phase is determined according to 1-cos(2ωt).

8. The controller of claim 1, wherein the first circuit comprises an average input current calculator that calculates an average input current for each phase in each switching cycle.

9. The controller of claim 6, wherein the feedback circuit determines an average value of the sensed output currents of the three phases over a half-line cycle, compares the output current of each phase to the average value of the three phase currents, and subjects the output of the comparison for each phase to a compensator to obtain an adjusting power signal for each phase.

10. The controller of claim 6, wherein the feature of the input voltage is determined at a zero-crossing point of the input voltage of each phase.

11. The controller of claim 1, wherein the feedback circuit compares a sensed output voltage of the three phase converter to a reference voltage, and uses the output of the comparison to obtain a proper amplitude of the at least one power control signal.

12. The controller of claim 1, comprising an output circuit including pulse width modulation (PWM) modules that generate switching signals for switching devices of power converter modules of the three phase power converter.

13. The controller of claim 1, comprising an output circuit including pulse frequency modulation (PFM) modules that generate switching signals for switching devices of power converter modules of the three phase power converter.

14. The controller of claim 1, implemented for a three-phase power converter configured for a phase voltage connected three-phase power source.

15. The controller of claim 1, implemented for a three-phase power converter configured for a line voltage connected three-phase power source.

16. A three phase power converter comprising the controller of claim 1.

17. A method for controlling a three phase power converter, comprising:
determining an instantaneous input power of each phase;
determining a power control signal for each phase based on an output power of the three phase power converter;
using the power control signal to determine a reference signal for each phase;
using the reference signal for each phase to adjust the instantaneous input power of each phase to achieve power balancing of the three phases;
wherein a double line frequency ripple in the ouput power of the three phase converter is substantially eliminated.

18. The method of claim 17, comprising:
sensing an input current and an input voltage for each phase of the three-phase converter, and determining the instantaneous input power for each phase;
using a feedback circuit that senses an output voltage of the three phase converter to determine the power control signal for each phase;
using the power control signal for each phase together with a feature of the input voltage for each phase to determine a reference power signal for each phase;
comparing the reference power signal for each phase to the instantaneous input power for each phase to generate a control signal for each phase;
using the control signal for each phase to generate drive signals for switching devices of power circuits of each phase of the three phase power converter.

19. The method of claim 18, wherein the feature of the input voltage for each phase is determined according to 1-cos(2ωt).

20. The method of claim 18, wherein the feedback circuit senses the output voltage and an output current of the three-phase converter;
the method comprising using the sensed output voltage to determine the power control signal for each phase, and using the power control signal for each phase together with a feature of the input voltage for each phase to determine a reference current signal for each phase;
using the sensed output current and voltage to determine an output power of the three-phase converter;
using the output power to determine an instantaneous input current of each phase that is used with the reference current signal for each phase to generate the control signal for each phase.

21. The method of claim 20, wherein the feature of the input voltage for each phase is determined according to sin(ωt).

22. The method of claim 18, wherein the feedback circuit senses the output voltage of the three phase converter and an output current of each phase to determine the power control signal for each phase;
the method comprising using the power control signal for each phase together with a feature of the input voltage for each phase to determine the reference power signal for each phase.

23. The method of claim 22, wherein the feature of the input voltage for each phase is determined according to 1-cos(2ωt).

24. The method of claim 17, comprising using pulse width modulation (PWM) to generate switching signals for switching devices of power converter modules of the three phase power converter to achieve power balancing of the three phases.

25. The method of claim 17, comprising using pulse frequency modulation (PFM) to generate switching signals for switching devices of power converter modules of the three phase power converter to achieve power balancing of the three phases.

26. The method of claim 17, double line frequency ripple in the output power of the three-phase converter is substantially eliminated with balanced input voltage and with unbalanced input voltage, and when input voltage harmonics are present.
